(19) United States
(12) Patent Application Publication
(10) Pub. No.: US 2003/0103490 A1
(43) Pub. Date: Jun. 5, 2003

(54) Integration of digital signal processor

(75) Inventors: Francis Edward Noel JR., Durham, NC (US); Charles Joseph Sannipoli, Raleigh, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/006,511

(22) Filed: Dec. 5, 2001

(51) Int. Cl. H04L 12/28

(52) U.S. Cl. 370/351; 370/255

(57) ABSTRACT

A Digital Signal Processor (DSP) is integrated within a network processor. The DSP is integrated as a core function and has an analog interface and/or a digital interface. The DSP may receive analog signals and convert them to digital signals which may undergo additional processing within the DSP. The output of the DSP maybe routed by the network processor to physical layer devices. The DSP may also receive digital signals which may be processed by the DSP's specialized operations. The combination network processor and DSP may be easily programmed to implement specialized communication and data handling functions.

### TECHNICAL FIELD

The present invention relates in general to the integration of specialized functions as core logic imbedded within a processor so the core logic may be used in place of written processor instructions, to provide additional functions not in a processor's instruction set.

### BACKGROUND INFORMATION

A network processor is a programmable central processor unit (CPU) that is optimized for networking and communications functions. It offers network equipment vendors an off-the-shelf alternative for building routers, switches and access devices much faster than by designing a custom application specific integrated circuit (ASIC) chip. The network processor is programmed to perform the packet processing supported by the device and is expected to be widely used in all but the lowest-end products. MMC Networks coined the term “network processor” in 1997.

A Media Access Control (MAC) layer refers to the protocol that controls access to the physical transmission medium on a Local Area Network (LAN). MAC layer functionality is built into the network adapter and includes a unique serial number that identifies each card. Common MAC layer standards are the Carrier Sense Multiple Access Collision Detection (CSMA/CD) architecture used in Ethernet and the token passing methods used in Token Ring, Fiber Distributed Data Interface (FDDI) and Manufacturing Automation Protocol (MAP). The MAC layer is synonymous with the data link control layer in the Open Systems Interconnect (OSI) model.

A network processor may interface at this level in the OSI model. The network processor receives signals from physical layer devices and then creates and transmits data packets via a switch fabric to other devices in one mode or is configured in a “Wrap-back” configuration in another mode. Wrap-back refers to the configuration where two switch fabric interfaces are coupled together with a network processor. The network processor may be programmed to provide functionality that was previously accomplished by a specially designed ASIC chip. An embedded processor complex (EPC) within the network processor has special purpose processors (sometimes called “Pico processors”) which may be programmed to carry out the functions necessary for packet generation and routing. Signals from physical layer devices are received and bused to an enqueue/dequeue scheduling unit (EDS) for “up linking” data to a switch fabric. The EDS unit is controlled by the EPC. The EPC may be programmed to conform to a particular user's protocols. Likewise, signals from the switch fabric are received by circuits in the network processors and routed by another EDS unit controlled by the EPC performing a traffic management function. The data from the switch fabric is forwarded to devices on the physical layer. The physical layer is responsible for passing bits onto and receiving them from the connecting medium. This layer has no understanding of the meaning of the bits, but deals with the electrical and mechanical characteristics of the signals and signaling methods. For example, it comprises the Request to Send (RTS) and Clear to Send (CTS) signals in an RS-232 environment, as well as Time Division Multiplexing (TDM) and Frequency Division Multiplexing (FDM) techniques for multiplexing data on a line. Synchronous Optical Network (SONET) also provides layer 1 capability.

A Digital Signal Processor (DSP) is a special-purpose processor used for performing complex mathematical processing on digital signals resulting from analog to digital (A/D) conversion. The DSP provides ultra-fast instruction sequences, such as shift and add, and multiply and add, which are commonly used in math-intensive signal processing applications. DSP technology is widely used in a myriad of devices, including sound cards, fax machines, modems, cellular phones, high-capacity hard disks and digital televisions. DSP refers to a category of techniques that are used to analyze signals from sources such as sound, weather satellites and earthquake monitors. Signals are converted into digital data and analyzed using various algorithms such as Fast Fourier Transform. Once a signal has been reduced to numbers, its components maybe isolated, analyzed and rearranged more easily than in analog form. DSP is used in many fields, including biomedicine, sonar, radar, seismology, speech and music processing, imaging and communications. DSP chips are used in sound cards for recording and playback, compressing and decompressing speech data and for speech synthesis. Other DSP chip uses include amplifiers that simulate concert halls and surround sound effects for music and home theater.

If a physical layer generates analog signals (e.g., audio and video), the analog signals must be first digitized and converted to digital signals before these signals may be packetized and coupled to the network processor. A/D converters may be used for this function and the resulting digital signals may be coupled to a network processor where they may be packetized for digital distribution. A physical layer device receiving the transmitted digital signals may use a digital to analog (D/A) converter to recover the analog data for use with an output device (telephone or video). If the analog signal needs to be processed (e.g., filtering), then either the processing is done in the analog domain or in the digital domain. Because of the power of digital signal processing, a DSP is often the choice when processing analog signals. If a DSP is to be used separate from a network processor chip in a communication application, then the user must handle the two functions separately which may limit the application of the DSP. With a DSP core as part of the network processor architecture, several major functions may be more easily realized. For example, analog signals may be brought directly into the network processor. Providing this DSP capability would greatly extend the capability of the network processor, especially in applications at the “edge” or access points of a communication network. For example, if an audio signal is brought into the network processor, it could be digitized by the DSP and then routed through an Internet Protocol (IP) network. Alternately, using pattern recognition algorithms possible with the network processor, the audio signal maybe analyzed for voice signatures or other characteristics. Similarly, video signals maybe brought into the DSP, digitized and either routed through an IP network or analyzed for such patterns as those required in oil exploration or other video analysis applications. Another application may utilize the DSP core to provide the physical interfacing functions of traditional MAC/PHY layers on a user customized basis.

There is, therefore, a need for a network processor where DSP functionality is integrated within the network processor so the flexibility of programming the network processor may be combined with the DSP functionality.

### SUMMARY OF THE INVENTION

A digital signal processor (DSP) functionality is integrated with a network processor. An analog interface is provided so that analog signals may be directly coupled to the DSP where the analog signals are converted to digital data which may be processed. The processed digital data may be packetized by the electronic processor complex (EPC) within the network processor and the resulting packets transmitted over the switch fabric to other physical layer devices. Data from a physical layer device, which has already been digitized, may be routed to the DSP for signal processing. The results of this processing may be used in determining how to direct the data or it may be converted back to analog data for receipt by another physical layer device. The network processor may also route digital data to the DSP where the functionality may be used to do high speed processing of a specialized nature.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram of a network processor;

FIG. 2 is a block diagram of units within the embedded processor complex (EPC) within the network processor;

FIG. 3 is a block diagram of one embodiment of the present invention where the DSP is integrated in place of a processor within the EPC;

FIG. 4 is a block diagram of one embodiment of the present invention where the DSP function is integrated within each processor in the EPC; and

FIG. 5 is a block diagram of one embodiment of the present invention where the DSP function is included external to the EPC in the network processor.

### DETAILED DESCRIPTION

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted in as much as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

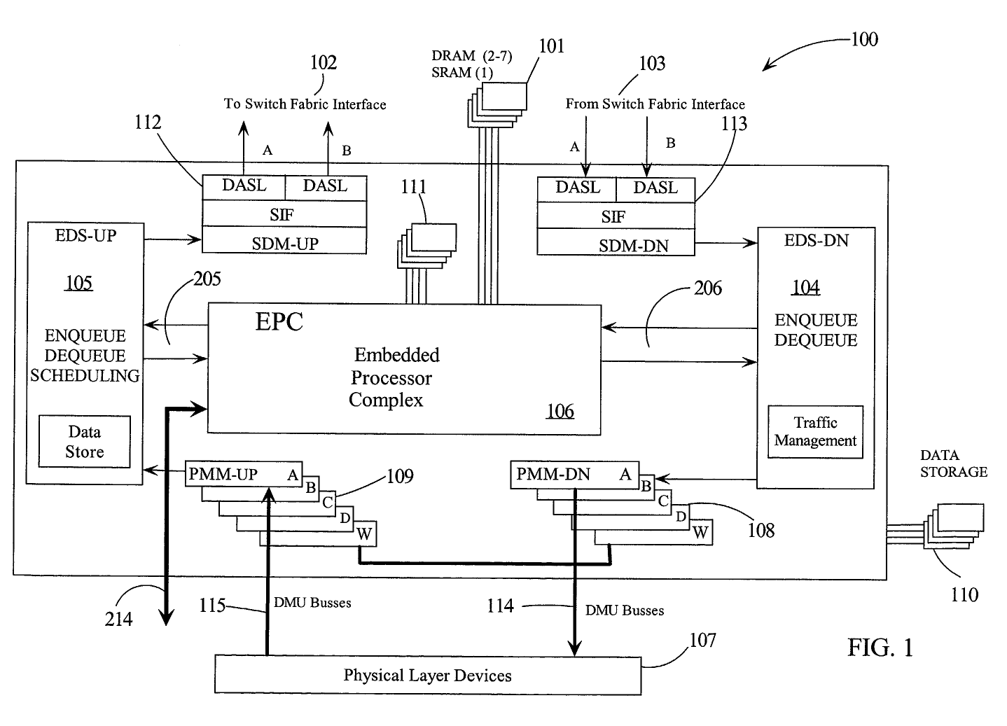

FIG. 1 is a block diagram of a network processor 100. Physical layer devices 107 have direct memory unit (DMU) busses 115 and 114 coupled to intermediate data storage PMM-UP 109 and PMM-DN 108 respectively. In this way, data is received from and transmitted to physical layer devices 107. EPC 106 couples to both Enqueue/Dequeue scheduler (EDS)-UP 105 and EDS-DN 104 units via connections 205 and 206 respectively (UP and DN represent directions of data flow). EPC 106 also has internal on chip storage 111. Selected units in EPC 106 use an interface connection 214 to the outside world (e.g., internet connection). Network processor 100 may also be coupled with external chip memory 101 comprising SRAM and DRAM, as well as Data storage 110. Data is coupled to EDS-UP 105 via Packet Memory Module (PMM)-UP 109 and interface unit 112 which couples to switch fabric interface 102. Interface unit 112 comprises serial data memory (SDM), a serial interface (SIF), and a data align serial link (DASL), which is an IBM proprietary interface. Other interfaces than DASL 112 may be used and still be within the scope of the present invention. Data comes from the switch fabric interface 103 via interface unit 113, which also comprises DASL, SIF and SDM-DN. The data is the coupled to EDS-DN 104 which in turn couples to PMM-DN 108. In this manner, data enters and is put in the desired packet protocol by EPC 106 and outputted to a physical layer device or back to the switch fabric. EPC 106 comprises special purpose processors (Pico Processors) which are programmable by a manufacturer but not the end-user. In this way, a manufacturer may customize the network processor 100 to their desired application without having to resort to making an ASIC. The processor engines in the EPC are sufficiently fast that the operation competes with a custom ASIC.

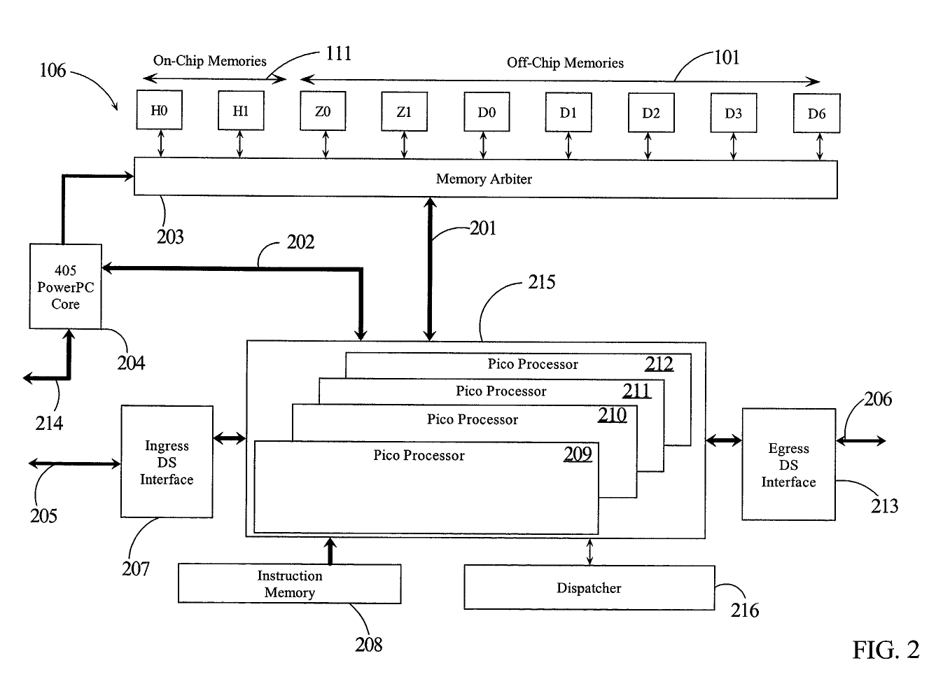

FIG. 2 is a block diagram showing more detail of the EPC 106. Various blocks are labeled and numbered for additional explanation. On-chip memories 111 are coupled via Memory Arbiter 203 to general purpose processor 204. In one embodiment of the present invention processor 204 is an IBM Type 405 PowerPC Core. Processor 204 is used to handle what is known as the control point which includes the fundamental operations of the network processor 100. While the processor 204 does a variety of operations (e.g., load registers, loads instructions for a particular code, etc.), its key functions are to run the control point and to act as an escape valve for the Pico processors 209-212 when they receive information (e.g., a particular data packet) which they have not been programmed to handle. Processor 204 has an interface 214 to the outside world (e.g., an internet port) so that it may be loaded with instruction code.

Pico processors 209-212 are special purpose processors that are transparent to a user. A manufacturer typically programs the Pico processors 209-212 to customize the network processor 100 for its application. Instruction memory 208 stores instructions for Pico processors 209-212. Dispatcher 216 handles the interface of the EPC 106 with the other units in the network processor 100. Ingress unit 207 couples signals from input 205 to the Pico processors 209-212. Likewise, egress unit 213 couples signals to output 206.

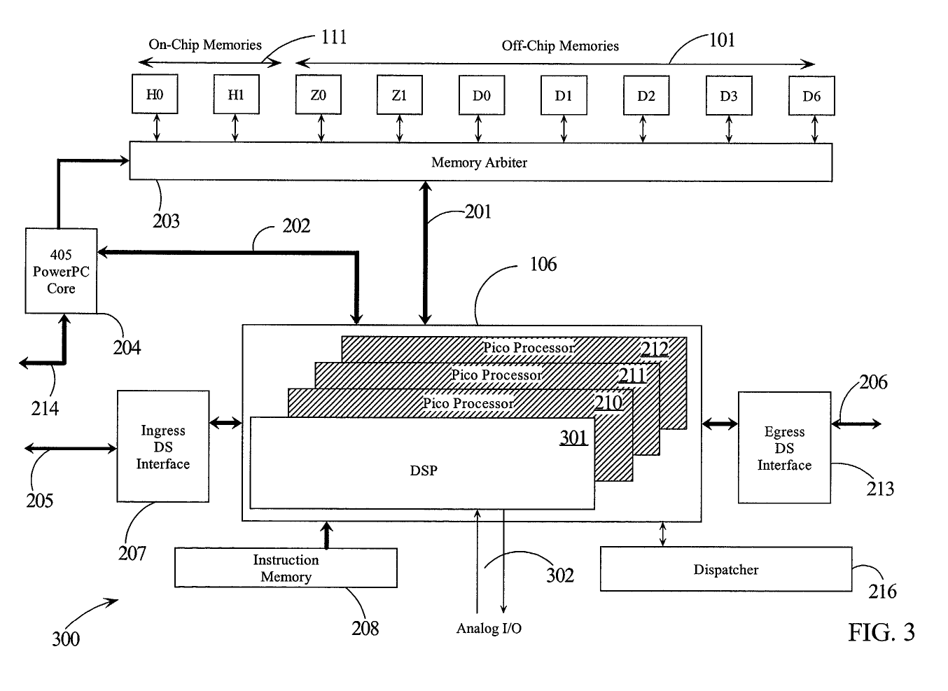

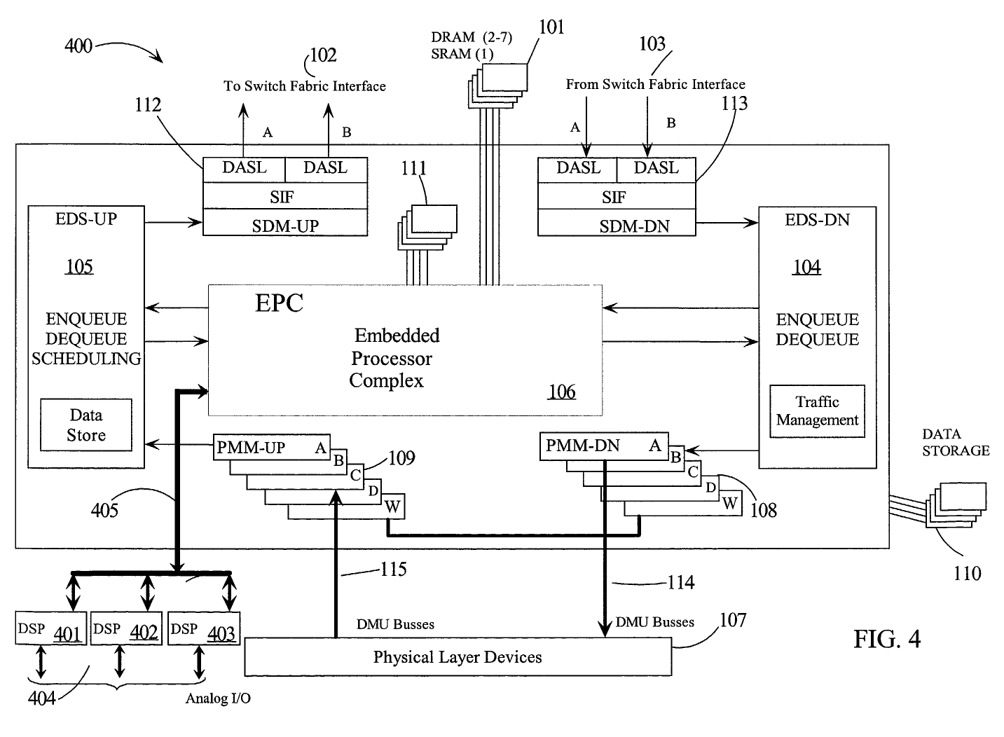

FIG. 3 illustrates a modified EPC 300 according to embodiments of the present invention. In this embodiment, DSP 301 is substituted for particular Pico processor 209 in FIG. 2. More than one DSP may be substituted and still be within the scope of the present invention. Analog I/Os 302 are used to receive analog signals and to generate analog results. The operation of DSP 301 may be controlled by general purpose processor 204. For example, analog signal inputs in analog I/Os 302 are digitized by DSP 301, but control over which of the DSP functions, in DSP 301, operate on these analog signals is controlled by instructions from processor 204. DSP 301 may also receive digital signals. Packets of data may be unpacked by processor 204 and the data processed by the special DSP 301 functions. The processed data may be again returned to processor 204 for re-packetizing for transmission over the switch fabric or in a network. Various types of digital signal processing are available without having to write instructions for the processor 405. Besides adding the functionality of an analog signal interface, the signal processing power of the DSP 301 enhances the performance of the network processor. FIG. 4 is a block diagram of network processor 400 in another embodiment of the present invention. DSPs 401-403 are outside of EPC 106 but have a digital interface 405 with the EPC 106. Analog I/Os 404 couple analog signals into and out of DSPs 401-403. DSPs 401-403 may also receive digital signals as well as programming over digital interface 405. Digital signals may be processed using the specialize functions of the DSP and the resulting digital outputs may be directed to switch fabric 102 or to other physical layer devices 107. The addition of the DSPs to the network processor 100 allows DSP functions to be used on digitized analog signals or digital signals. Since the DSPs are coupled into the network processor, the communication flexibility of the network processor is enhanced to allow new features that may not be possible by programming a general purpose processor in EPC 106 (e.g., processor 204).

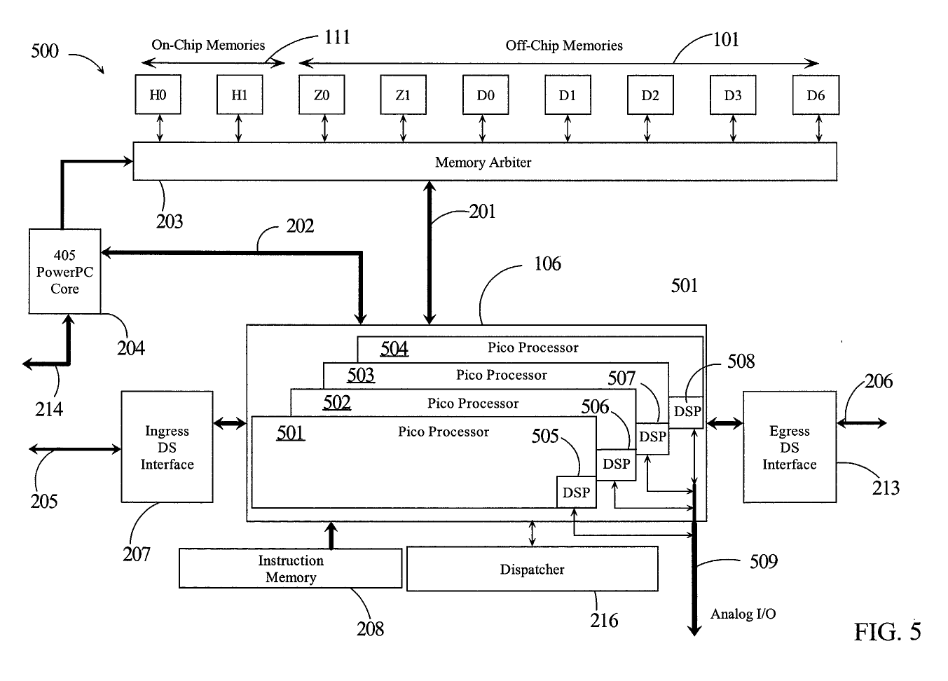

FIG. 5 is a block diagram of network processor 500 in another embodiment of the present invention where DSP cores 505-508 are integrated into each Pico processor 501-504 respectively. Each DSP 505-508 may have an analog I/O depicted by signals 509.

The above embodiments of the present invention have shown how the power of a DSP core may be integrated into the functionality of a network processor. In this way the flexibility of the network processor 100 may be enhanced by the DSP functionality for processing both analog and digital signals. Processed digital data from the DSPs may then be packetized for distribution over a switch fabric or to a network configured with several network processors.

Although the present invention and its advantages have been described in detail, it should be understood that various changes, substitutions and alterations can be made herein without departing from the spirit and scope of the invention as defined by the appended claims.

What is claimed is:

1. An integrated circuit (IC) for data communication comprising:
circuitry for receiving digital signals from devices within a communication network;
circuitry for receiving analog signals from a selected one of said devices;
circuitry for routing said analog and digital signals to a digital signal processor (DSP), said DSP outputting processed signals in response to DSP programming commands;
circuitry for incorporating particular processed digital signals into data packets corresponding to a communication protocol; and
circuitry for receiving and transmitting said data packets of a communication protocol to and from a network coupling said physical layer devices.

2. The IC of claim 1 further comprising circuitry for outputting analog signals derived from particular ones of said processed signals from said DSP to a particular one of said physical layer devices.

3. The IC of claim 1, wherein said DSP receives digital data not derived from a corresponding analog signal.

4. The IC of claim 1, wherein selected first digital data from said DSP are analyzed by a network processor to determine a characteristic of said first digital data, said characteristic used in said network processor to direct a dispensation of said first digital data.

5. The IC of claim 4, wherein said processing to determine said characteristic of said first digital data comprises a pattern recognition algorithm.

6. A network processor comprising:
an embedded processor complex (EPC) with multiple processors;
a first communication interface to physical layer devices;
a second interface to a switch fabric;
a memory storage unit;
a digital signal processor (DSP) having an analog I/O and a digital I/O interface; and
a bus system for coupling said EPC, said physical layer devices, said switch fabric, said storage unit and said DSP.

7. The network processor of claim 6, wherein said DSP is one of said multiple processors in said EPC.

8. The network processor of claim 6, wherein said DSP is a functional core integrated into each one of multiple processors in said EPC.

9. The network processor of claim 6, wherein said DSP is a functional core external to said EPC, said DSP coupled to said EPC and to one of said physical layer devices.

10. The network processor of claim 6, wherein said DSP has an analog signal interface for receiving and sending analog signals and a digital signal interface for sending and receiving digital signals.

11. The network processor of claim 6, wherein said DSP receives program commands via said switch fabric from a remote device.

12. The network processor of claim 6, wherein said DSP receives program commands via a general purpose processor in said network processor.

13. A method for improving the performance and functionality of a network processor controlling the communication between physical layer devices comprising the steps of:
adding a DSP core to said network processor;
coupling digital signals to and from said network processor and said DSP;
executing instructions by said DSP to determine a characteristic of said digital signals; and
directing a dispensation of said digital signals based on said determined characteristic.

14. The method of claim 13 further comprising the steps of:
coupling analog signals to said DSP;
digitizing said analog signals;
processing said digitized analog signals by said DSP;
incorporating said processed digital signals into data packets corresponding to a communication protocol; and
receiving and transmitting said data packets of said processed digital signals to said physical layer devices on a communication network coupled to said network processor.

15. The method of claim 14 further comprising the step of:
outputting analog signals converted from said processed digital signals to a particular physical layer device.

16. The method of claim 13, wherein said DSP is one of multiple processors in an embedded processor complex in said network processor.

17. The method of claim 13, wherein said DSP is a functional core integrated into one of multiple processors in a embedded processor complex in said network processor.

18. The method of claim 13, wherein said DSP is a functional core coupled to an embedded processor complex in said network processor one of said physical layer devices.

19. The method of claim 13, wherein said DSP has an analog signal interface for receiving and sending analog signals and a digital signal interface for sending and receiving digital signals.

20. The method of claim 13, wherein said DSP receives program commands via a switch fabric coupled to said network processor from a remote device.

21. The method of claim 13, wherein said DSP receives program commands via a general purpose processor in said network processor.
